(19) United States
(12) Patent Application Publication
(10) Pub. No.: US 2020/0349592 A1
(43) Pub. Date: Nov. 5, 2020

(54) IDENTIFICATION OF ANOMALIES ON A TRANSACTION NETWORK

(71) Applicant: SAP SE, Walldorf (DE)

(72) Inventors: Kavitha Krishnan, Bangalore (IN); Naga Sai Narasimha Guru Charan Koduri, Vijayawada (IN); Kumar Nitesh, Fatehpur (IN)

(21) Appl. No.: 16/403,021

(22) Filed: May 3, 2019

(51) Int. Cl. G06Q 30/02; G06Q 40/04; G06F 17/18; G06N 5/04

(52) U.S. Cl. CPC G06Q 30/0201; G06N 5/041; G06F 17/18; G06Q 40/04

(57) ABSTRACT

Briefly, embodiments of a system, method, and article for processing a set of indicators from an indicator repository are disclosed. An indicator anomaly may be detected within one of more of the individual indicators of the set of indicators based, at least in part, on a threshold increase in publication of the one or more of the individual indicators within a particular time period. A determination may be made as to whether one or more particular indicators of the set of indicators had a causal impact on a transactions anomaly within the particular time period. A notification may be generated to identify the one or more particular indicators at least particularly in response to the determining that the one or more particular indicators of the set of indicators had a causal impact on a transactions anomaly.

### BACKGROUND

Transaction networks such as electronic marketplaces are becoming more and more prevalent places for buyers and seller to conduct business. One such transaction network is SAP's Ariba™ network, an electronic marketplace through which billions of dollars of transactions are conducted on a daily basis and trillions of dollars on an annual basis. A transaction network may comprise a cloud-based business-to-business (“B2B”) electronic marketplace where buyers and suppliers can locate each other and do business to engage in financial transactions, for example, within a single networked platform.

The monetary value of transactions conducted over a transaction network may be affected by the occurrence of various economic events. For example, if the price of copper spikes, the monetary value of financial transactions conducted across a transaction network for items made of copper may be adversely affected. Currently, if one were to look solely at the monetary value of transactions, a disruption in overall financial transactions within a transaction network as a whole or within a portion of transaction network, such as within a particular industry, for example, may be detected, although a cause of the disruption may be unknown. A wealth of knowledge potentially related to disruptions in the monetary value of economic transactions is currently shared on social media platforms, such as Twitter™ or Facebook™, for example, but the information shared on the social media platforms is not currently utilized to identify causes of disruptions over a transaction network such as an electronic marketplace.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates an embodiment of a system for detecting one or more financial transactions anomalies and economic indicator anomalies and generating associated notifications according to an embodiment.

FIGS. 2A and 2B illustrate two time-series of data according to an embodiment.

FIG. 3 illustrates an embodiment of an anomaly detection server.

FIG. 4 illustrates an embodiment of an economic indicator repository according to an embodiment.

FIG. 5 illustrates an embodiment of a process for determining whether a particular economic indicator had a causal impact on a transaction network according to an embodiment.

FIG. 6 illustrates an embodiment of a process for determining whether any economic indicators note previously monitored had a causal impact on a transaction network according to an embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

The occurrence of certain events may affect financial transactions made or conducted across an electronic marketplace, such as a transaction network or some other financial network such as Amazon™ or eBay™, for example. Various embodiments are described below with respect to a transaction network. It should be readily appreciated, however, that the teachings herein are equally applicable to other financial marketplaces or networks, for example.

An occurrence of a powerful earthquake in a country which is a major supplier of certain raw materials may have an immediate impact on the price of such raw materials. If, for example, the price of copper spikes by 20% shortly after an earthquake, a supplier of copper ore may quickly raise the price for raw copper sold on a transaction network. By raising the price, for example, fewer buyers may choose to purchase the raw copper after the price increase. For example, a business may either choose to delay purchase of the copper ore in anticipation of the price of copper ore decreasing or leveling off or may entirely forego purchase of the copper ore and may instead choose to utilize a replacement material other than copper ore if there are available alternatives.

If a transaction network as a whole, a portion of the transaction network, such as a particular industry or sales group within the transaction network, a particular company, and/or a particular geographical region, is monitored, for example, a change in the value of financial transactions conducted across the network may be detected over time. For example, a moving average of the total value of financial transactions conducted over the transaction network or within a segment of the transaction network may be determined and monitored. In one particular embodiment, a value of all financial transactions conducted over a seven-day period may be determined and updated periodically, such as every hour. For example, because there are 24 hours in a day, if the total value of all transactions conducted over the transaction network is monitored over a 7-day period of time, then the financial value of transactions conducted over a 168-hour period of time may be determined and may be continuously updated periodically, such as every hour, for example, to determine a new moving average. If, for example, the total value of financial transactions conducted over the transaction network changes by more than a threshold percentage between successively determined moving averages, an anomaly may therefore be detected within the transaction network.

An “anomaly,” as used herein, refers to a difference between successive values of a time-series of data values which equals or exceeds at least a threshold amount. For example, an anomaly within a financial marketplace, such as the transaction network, may comprise a sudden and unexpected mutation in financial transactions. An anomaly within a financial marketplace is referred to herein as a “transactions anomaly” or a “financial transactions anomaly,” e.g., for the sake of clarity. Accordingly, a financial transactions anomaly within the transaction network may comprise a spike up or down in terms of the amount of money spent on financial transactions within a particular period of time, for example. In one embodiment, a financial transactions anomaly may include a difference between successive moving average values of aggregate financial value which differ by 20% or more. Accordingly, if t1 of a time series of moving averages has a value of 1.0× and t2 of the time series of moving averages has a value which is at least 20% larger or at least 20% smaller, e.g., a value of 1.20× or more, or a value of 0.80× or less where t1 and t2 comprise successive values of a time series, a financial transactions anomaly may be detected or identified. It should be appreciated that a value of 20% is just one particular example of a threshold difference between values of time series data and that it should be appreciated that in some embodiments, a different threshold value may be utilized which is greater than or less than 20%, depending on the particular application, for example. Moreover, although an example of time series for a moving average over a 7-day period updated every hour is utilized in an embodiment as discussed above, the length of the time series and the rate of update of the moving average may differ. For example, in a particular embodiment, a moving average may be determined for a month-long period of time and the moving average may be updated daily. In another example embodiment, a moving average may be determined over a 2-hour period of time and may be updated every 5 minutes, for example. It should be additionally appreciated that a threshold value utilized to detect a financial transactions anomaly may be at least partially dependent upon a length of time for which a moving average is determined. For example, if a moving average is determined over a 2-hour period of time and is be updated every 5 minutes, a larger threshold value may be considered than may be for a time series for a moving average determined over a 7-day period and updated every hour.

If a financial transactions anomaly on the transaction network is detected, one or more embodiments, such as discussed herein, may identify a potential economic or condition indicator indicative of a cause of the financial transactions anomaly, for example. In other words, one or more embodiments, as discussed herein, may identify a likely cause of a financial transactions anomaly on the transaction network. There is a wealth of knowledge available on certain social media platforms, for example, which may be analyzed to identify a likely cause of a financial transactions anomaly. For example, a social media platform such as Twitter™, Facebook™, or Instagram™, to name just a few examples among many, may be monitored to identify a likely cause of a financial transactions anomaly on the transaction network. It should be readily appreciated, however, the teachings discussed herein are equally application to other social media platforms or networks, for example.

In one particular embodiment, certain trending economic indicator hashtags or handles may be monitored on a social media platform, for example, to determine whether any of these economic indicators are likely indicative of a cause of a financial transactions anomaly detected on the transaction network. A “hashtag” as used herein, refers to a keyword or a phrase used to describe a topic or a theme. Social media platform users, for example, may include hashtags in their tweets to categorize them in a way that makes it easy for other users to find and follow tweets about a specific topic or theme. In a social media platform, for example, a hashtag may be denoted by a “#” followed by a keyword or phrase. A posting such as a tweet on a social media platform may comprise information published, such as via posting, by a user on the social media platform, for example. A topic such as a particular economic indicator may be considered to be “trending,” for example, if a corresponding hashtag for the topic or economic indicator is one of the most commonly used or popular hashtags for tweets published within a certain time frame on the social media platform, such as within the prior 15 minutes or hour.

In an embodiment, a certain core set of hashtags relating to certain economic indicators may be monitored to detect a presence of an anomaly on the social media platform. Accordingly, two types of anomalies may be detected in accordance with an embodiment—one or more financial transactions anomalies on the transaction network and one or more anomalies of publications of economic indicators on the social media platform. An anomaly within a social media platform such as the social media platform is referred to herein as an “economic indicator anomaly,” e.g., for the sake of clarity. As discussed above, one or more financial transactions anomalies may be detected on the transaction network if there is a spike up or down in terms of the amount of money spent on financial transactions within a particular period of time, such as a moving time window, for example. An economic indicator anomaly may similarly be detected for a particular economic indicator on the social media platform, e.g., if there is a sudden spike up or down in terms of publications of a hashtag for the economic indicator within a particular period of time. For example, economic indicator anomaly for a particular economic indicator may be detected if there is at least a threshold increase (or decrease) in the publication of a hashtag corresponding to the economic indicator within a predefined time period. In one embodiment, the predefined time period or moving time window may be set by the social media platform itself. In other embodiments, the predefined time period or moving time window may be selected by an end user or a platform monitoring the social media platform, for example.

As discussed further below, economic indicator anomalies may be detected in terms of publication of hashtags relating to certain economic indicators and if such an economic indicator anomaly is detected, a determination may be made as to whether there is a causal relationship between the economic indicator anomaly and a financial transactions anomaly detected on the transaction network. For example, a causality test, such as the Granger Causality Test as discussed below, may be implemented to determine whether there is a causal relationship between an economic indicator anomaly and a financial transactions anomaly. If there is determined to be a causal relationship between the economic indicator anomaly and the financial transactions anomaly, then an alert may be generated to, e.g., notify an end user of the cause of the financial transactions anomaly.

In another embodiment, additional economic indicators other than the initial core set of economic indicators may be identified. For example, if it has been determined that an economic indicator anomaly for a particular economic indicator had a causal relationship to a financial transaction anomaly, additional economic indicators related to the particular economic indicator may be identified for future monitoring.

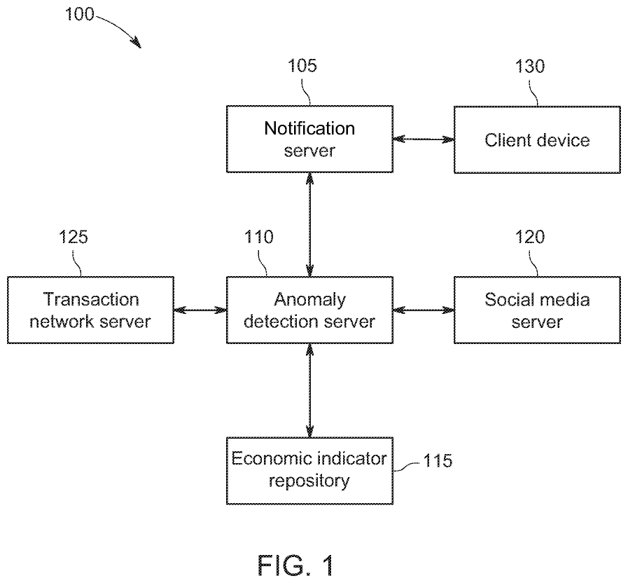

FIG. 1 illustrates an embodiment 100 of a system for detecting one or more financial transactions anomalies and economic indicator anomalies and generating associated notifications according to an embodiment. As show, embodiment 100 may include a notification server 105, an anomaly detection server 110, an economic indicator repository 115, a social media server 120, a transaction network server 125, and a client device 130, for example.

In embodiment 100, anomaly detection server 110 may be in communication with social media server 120 via a network, such as the Internet, to monitor publication of certain economic indicators or other trending topics. For example, social media server 120 may comprise a media server for a social media platform, to name just a couple examples among many. For example, social media server 120 may comprise a media server for any platform in which entitles may periodically publish information about various topics. For example, a user of such a social media platform may utilize a hashtag or some other type of handle to categorize or otherwise indicate a subject or topic associated with certain published information. For example, a user may publish an item, such as by posting or tweeting a social media item. In a particular implementation, a user may publish a link to a news article about the price of gold followed by a hashtag such as “#Gold” or “#PreciousMetals,” for example. If enough users publish social media posts with the same hashtag on the social media platform within predefined time period, such as within the previous hour, for example, the hashtag may be considered to comprise a trending topic or hashtag. In one particular implementation, the 20 most popular hashtags utilized within the predefined time period may be considered to comprise trending topics or hashtags, for example.

Anomaly detection server 110 may periodically call an Application Programming Interface (API) to generate a request to transmit to social media server 120 to request a list of trending topics or information relating to certain economic indicators of a set of monitored economic indicators, for example. In one embodiment, anomaly detection server 110 may call an API to generate a request at periodic intervals of time, for example, such as every five minutes, or every hour, for example. In an embodiment, the periodic interval may time may be configurable by anomaly detection server 110, for example.

For example, anomaly detection server 100 may periodically receive messages from social media server 120 which indicate the number of times certain economic indicators and/or other trending topics were published within a predefined time period. In some embodiments, anomaly detection server 100 may periodically receive messages from social media server 120 only if hashtags for certain economic indicators comprise trending topics within the predefined time period. In accordance with certain embodiments, anomaly detection server 100 may receive messages from social media server 120 which indicate a total number of publications of certain select hashtags within a predefined time period and/or a total number of publications of all hashtags having a threshold minimum number of publications with the predefined time period, for example.

Anomaly detection server 110 may process messages received from social media server 120 to generate a time series of data points for select hashtags being monitored. For example, if messages are received from social media server 120 at periodic intervals indicating how many times a particular hashtag was associated within a publication of a particular economic indicator in a social media post within the time internal, a time series of data points may be determined for a particular economic indicator. Table 1 as shown below illustrates an example of the number of publications of the economic indicator #FED at ten different points during an interval of time, e.g., t0-t9. As discussed previously above, the time values may be equally spaced in terms of time.

TABLE 1
Publications of economic indicator #FED

| | # of | Moving | |
|---|---|---|---|
| | Publications | average | % Increase |
| | of | of past | in moving |
| Time | economic | four | average |
| value | indicator | publications | between |
| t0 | 25 | — | |
| t1 | 28 | — | |
| t2 | 21 | — | |
| t3 | 29 | 25.75 | |
| t4 | 22 | 25.00 | −2.91% |
| t5 | 26 | 24.50 | −2.00% |
| t6 | 52 | 32.25 | 31.63% |
| t7 | 65 | 41.25 | 27.91% |
| t8 | 62 | 51.25 | 24.24% |
| t9 | 58 | 59.25 | 15.61% |

In the example above, a time series {t0, t1, t2, t3, t4, t5, t6, t7, t8, t9} for economic indicator #FED may comprise values {25, 28, 21, 29, 22, 26, 52, 65, 62, 58}. A moving average for four successive publications of economic indicator #FED may be determined, starting with time value t3 in this example. For example, values of moving averages between time values t3 and t9 may comprise the values {25.75, 25.00, 24.50, 32.35, 41.25, 51.25 59.25}. A % increase between successive moving average values may also be determined. In this example, the % increase between moving average values starting between the moving averages between times t3 and t4 and repeating through the % increase between moving averages between times t8 and t9 may be determined to comprise values {−2.91%, −2.00%, 31.63%, 27.91%, 24.24%, 15.61%}. Accordingly, if an economic indicator anomaly is identified where a % increase between successive values of a moving average of a time series differs by a threshold value of at least 20% from a prior moving average value, anomalies may be detected between times t6 and t9. In one particular example, the presence of four successive different values of a % increase between successive values of a moving average of a time series exceeding a threshold value, as shown in the example of Table 1, may indicate the presence of one economic indicator anomaly, although in some embodiments the presence of four successive different values of a % increase between successive values of a moving average of a time series exceeding a threshold value may instead be indicative of four economic indicator anomalies, for example.

If an economic indicator anomaly is detected in publication of an economic indicator, subsequent processing may be performed to determine whether the economic indicator anomaly of the economic indicator had a causal impact on financial marketplace transactions on the transaction network, for example. For example, as discussed above, the total value of all financial transactions performed on a financial marketplace or transaction network may be monitored and determined at periodic intervals. For example, the value of all financial transactions may be calculated at the same time intervals as which publication of economic indicator tags on the social media platform are determined. Accordingly, a determination may be made as to whether the presence of an economic indicator anomaly on the social media platform has a causal effect on a financial transactions anomaly on the transaction network, for example.

Accordingly, the moving values of financial transactions conducted over the transaction network may be calculated over time and if the value of the moving average of financial transactions conducted differs by at least a threshold percentage, a financial transactions anomaly on the transaction network may therefore be detected. In one particular embodiment, a threshold percentage may comprise a difference of at least 20%, although it should be appreciated that a different threshold percentage may be utilized depending on the particular application. It should also be appreciated that the threshold percentage for detecting a financial transactions anomaly on the transaction network may be different from the threshold percentage to detect an economic indicator anomaly in publications of economic indicators on the social media platform. In one particular embodiment, an economic indicator anomaly in publication of economic indicators may be determined based on a threshold percentage difference between successive values of a moving average of publications of an economic indicator may comprise a difference of at least 20%, whereas a financial transactions anomaly in financial transactions on the transaction network may be determined based on a threshold percentage difference between successive values of a moving average of a value of financial transactions comprising a difference of at least 15%, for example.

If an economic indicator anomaly and a financial transactions anomaly have both been detected, a determination may be made as to whether the economic indicator anomaly had a causal impact on the financial transactions anomaly. For example, a causality test or calculation may be performed or otherwise implemented. For example, a Granger causality test may be performed on time series data or information relating to both the economic indicator anomaly and the financial transactions anomaly to determine whether there is a causal relationship.

The Granger causality test is a statistical hypothesis test for determining whether one time series is useful in forecasting another. For example, the Granger causality test measures an ability to predict the future values of a time series using prior values of another time series. A time series X is said to Granger-cause time series Y if it can be shown, such as through a series of lagged values of time series X (and with lagged values of Y also included), that the values of time series X provide statistically significant information about future values of time series Y.

In accordance with the Granger causality test, a causality relationship may be based on two principles, e.g., (a) a cause happens prior to its effect; and (b) the cause has unique information about the future values of its effect. Given these two assumptions about causality, the Granger causality test is designed to test the following hypothesis shown in Relation 1 for identification of a causal effect of time series X on time series Y:

[symbol]

[Y(t+1)∈A| [symbol] (t)]≠ [symbol] [Y(t+1)∈A| [symbol] ₋ₓ(t)] [Relation 1]

In Relation 1, [symbol] comprises a probability, A comprises an arbitrary non-empty set, [symbol] (t) and [symbol] ₋ₓ(t) respectively denote information available as of time t in the entire universe, and that in the modified universe in which X is excluded. If the above hypothesis shown in Relation 1 is accepted, one may say that X Granger-causes Y.

If a time series is a stationary process, the Granger causality test may be performed using the level values of two (or more) variables. If the variables are non-stationary, then the test is done using first (or higher) differences. The number of lags to be included is usually chosen using an information criterion, such as the Akaike information criterion or the Schwarz information criterion. Any particular lagged value of one of the variables is retained in the regression if (1) it is significant according to a t-test, and (2) it and the other lagged values of the variable jointly add explanatory power to the model according to an F-test. Then the null hypothesis of no Granger causality is not rejected if and only if no lagged values of an explanatory variable have been retained in the regression. In practice it may be found that neither variable Granger-causes the other, or that each of the two variables Granger-causes the other.

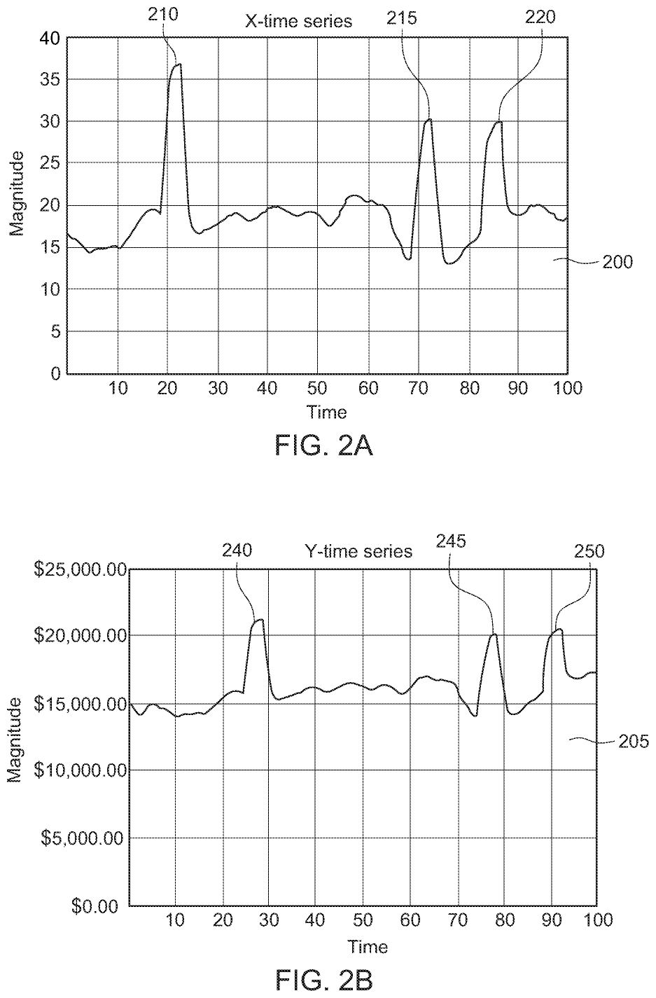

FIGS. 2A and 2B illustrate two time-series of data according to an embodiment. FIG. 2A illustrates a chart 200 of a time-series of data for a first variable, denoted as X. FIG. 2B illustrates a chart 205 of a time-series of data for a second variable, denoted as Y. Charts 200 and 205 each display a vertical axis which is indicative of a magnitude of a variable and a horizontal axis which is indicative of a time value. In this example charts 200 and 205 each display time values between 0 and 100 along a horizontal axis, but different values of magnitude along a vertical axis. For example, chart 200 indicates values of magnitude between 0 and 40 along a vertical axis, whereas chart 205 indicates currency values of magnitude of between $0.00 and $25,000.00 along its vertical axis. Although charts 200, 205 show different units of values for magnitude along a vertical axis, it should be appreciated that in some embodiments, the same units may be displayed along the vertical axis of different charts.

In this example, the Granger-causality test may be performed to determine whether time series X shown in chart 200 has a causal relationship to time series Y shown in chart 205 within a particular time period or threshold, such as a within a moving time window, such as a causal impact of an anomaly on time series X having a causal impact on an anomaly on time series Y within a one hour moving time window. For example, three distinct anomalies may be observed in chart 200—a first anomaly 210 located at approximately time 21, a second anomaly 215 located at approximately time 72, and a third anomaly 220 starting at approximately time 84. In this example, three distinct anomalies may also be observed in chart 205—a first anomaly 240 located at approximately time 28, a second anomaly 245 located at approximately time 77, and a third anomaly 250 starting at approximately time 92. Accordingly, as shown, charts 200 and 205 each have three distinct anomalies, although the occurrence of the anomalies shown in chart 205 are shifted in time relative to those in chart 200. Moreover, the X-time series shown in chart 200 is more volatile as indicated by sharper increases/decreases in various successive magnitude values relative to those of Y-time series shown in chart 205.

However, even though charts 200 and 205 differ in some ways, application of a Granger-causality test may indicate that the X-time series shown in chart 200 does have a causal relationship to the Y-time series shown in chart 205. Accordingly, a determination may therefore be made that X-time series may be predictive of Y-time series.

Referring back to FIG. 1, a Granger-causality test may be performed on various economic indicators which are monitored and exhibit anomalies. If, for example, application of the Granger-causality test indicates that an economic indicator anomaly for a particular tracked economic indicator exhibits a causal relationship to a financial transactions anomaly detected on the transaction network, anomaly detection server 110 may transmit a message to notification server 105 to indicate that the economic indicator anomaly for a particular tracked economic indicator did have a causal relationship to a financial transactions anomaly on the transaction network. In one particular example, notification server may transmit a message to a client device 130 to indicate that the particular economic indicator is related to a particular anomaly detected on the transaction network. In some embodiments, notifications may instead be maintained internally for further analysis, such as to predict future impact on the transaction network, for example.

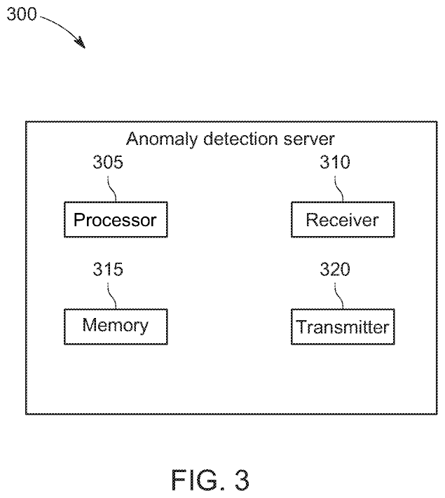

FIG. 3 illustrates an embodiment 300 of an anomaly detection server. For example, anomaly detection server embodiment 300 may include a processor 305, a receiver 310, a memory 315, and a transmitter 320, to name just a few example components among many possibilities. For example, receiver 310 may receive a message or other information from a social media server, such as a server for the social media platform, as discussed above with respect to FIG. 1. The message received may include the number of publications of hashtags or handles for certain economic indicators, as measured at periodic intervals, for example. Processor 305 may, for example, execute program code or instructions stored in memory 315 to process signals received by receiver 310 to determine whether an economic indicator anomaly has occurred, for example.

Receiver 310 may also receive messages from transaction network server 125 indicative of financial transactions conducted over the transaction network, for example. For example, the messages may indicate a total monetary value of transactions conducted across the transaction network or a select portion of the transaction network, as measured at periodic intervals of time. Processor 305 may, for example, execute program code or instructions stored in memory 315 to process signals received by receiver 310 to determine whether the transactions conducted across the transaction network are indicative of a presence of a financial transactions anomaly, for example.

Processor 305 may additionally, for example, determine where there is a causal relationship between a detected economic indicator anomaly and a financial transactions anomaly on the transaction network, for example. If a causal relationship is detected, for example, transmitter 320 may transmit a message to a notification server, such as discussed above with respect to FIG. 1, to indicate the presence of the causal relationship.

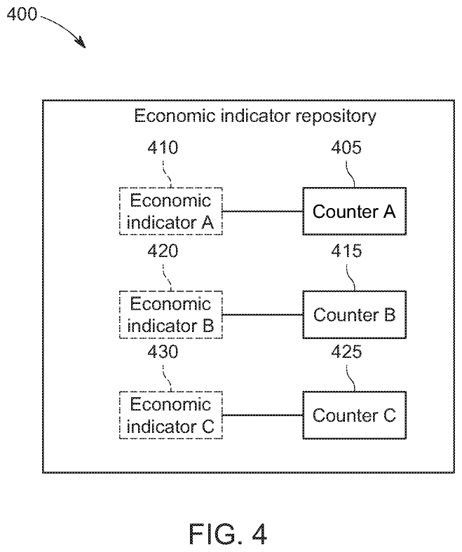

FIG. 4 illustrates an embodiment 400 of an economic indicator repository according to an embodiment. As shown, economic indicator repository may include a Counter A 405 for an Economic Indicator A 410, a Counter B 415 for an Economic Indicator B 420, and a Counter C 425 for an Economic Indicator C. Three counters and corresponding economic indicators are illustrated in embodiment 400 for the sake of simplicity. However, it should be appreciated that more or fewer than three counters and corresponding economic indicators may be monitored in certain embodiments, for example.

A counter in accordance with embodiment 400 may be utilized to maintain a score for a corresponding economic indicator. For example, publication of economic indicators on the social media platform having a minimum threshold score may be monitored in accordance with an embodiment. Accordingly, system performance may be improved, for example, by monitoring the economic indicators which are determined to be most relevant to transactions conducted on the transaction network, such as those having relatively higher scores. One or more counters may be added to economic indicator repository of embodiment 400 at certain times for additional or new economic indicators determined to be relevant to financial transactions conducted over the transaction network, for example Moreover, in some embodiments, one or more counters may be removed from economic indicator repository of embodiment 400 at certain times for certain economic indicators determined to not be sufficiently relevant to financial transactions conducted over the transaction network, for example.

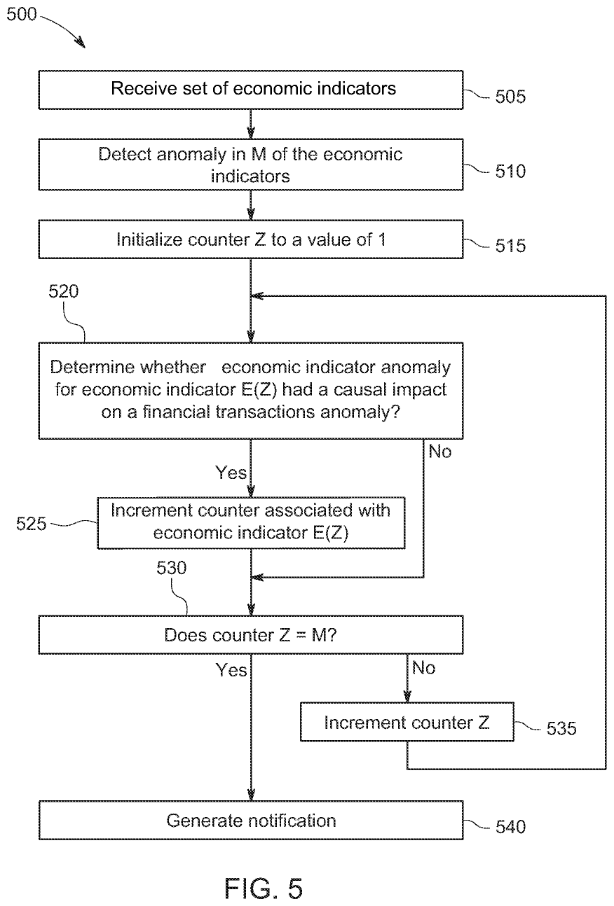

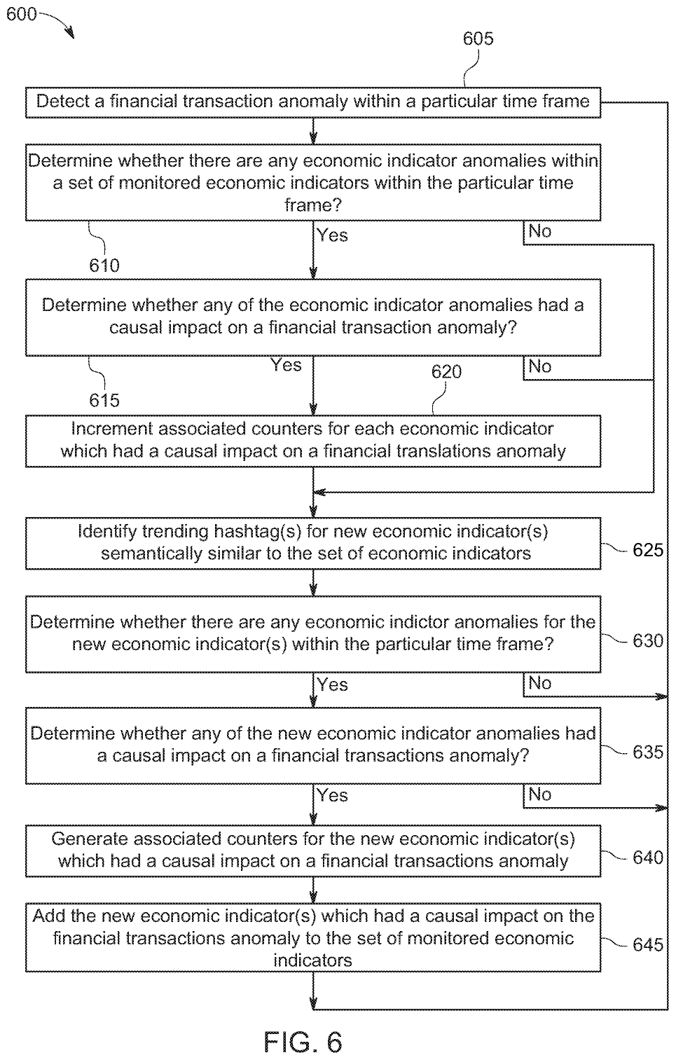

FIG. 5 illustrates an embodiment 500 process for determining whether a particular economic indicator had a causal impact on the transaction network according to an embodiment. Embodiments in accordance with claimed subject matter may include all of, less than, or more than blocks 505 through 540. Also, the order of blocks 505 through 540 is merely an example order. At operation 505, a set of economic indicators may be received. For example, the set of economic indicators may comprise a set of predefined economic indicators and/or additional economic indicators subsequently added to the set, such as discussed below with respect to FIG. 6. For example, the set of predefined economic indicators may relate to procurement of goods and/or services on the transaction network, such as #procurement, #logistics, #purchasing, #supplychain, #rfp, #contracts, and/or #sourcing, to name just a few examples among many.

At operation 510, an anomaly may be detected in M economic indicators of the set of economic indicators. At operation 515, a counter Z may be initialized to a value of 1. At operation 520, a determination may be made as to whether an economic indicator anomaly for economic indicator E(z) had a causal impact on a financial transactions anomaly on the transaction network. If “yes,” a counter associated with economic indicator E(z) may be incremented at operation 525 and processing may proceed to operation 530. If “no” at operation 520, processing may proceed to operation 530 where a determination may be made as to whether counter Z has the same value as M, which would indicate that the last of the M economic indicators is being analyzed. If “no,” counter Z may be incremented at operation 535 and processing may proceed to operation 520. On the other hand, if “yes,” at operation 535, processing may proceed to operation 540 where a notification may be generated to indicate which, if any of the M economic indicators, were determined to have a causal impact on a financial transactions anomaly detected on the transaction network, for example.

FIG. 6 illustrates an embodiment 600 process for determining whether any economic indicators not previously monitored had a causal impact on a financial transactions anomaly on the transaction network according to an embodiment. Embodiments in accordance with claimed subject matter may include all of, less than, or more than blocks 605 through 645. Also, the order of blocks 605 through 645 is merely an example order. At operation 605, a financial transactions anomaly on the transaction network within a particular time frame may be detected. At operation 605, a determination may be made whether there are economic indicator anomalies within a set of economic indicators within the same time frame. If “no” at operation 610, processing may advance to operation 625. If “yes” at operation 610, processing may advance to operation 615 where a determination may be made as to whether there are any economic indicator anomalies within the set of economic indicators which had a causal impact on a financial transactions anomaly within the transaction network. If “no” at operation 615, processing may advance to operation 625. If “yes” at operation 615, associated counters may be incremented for each economic indicator of the set which are determined to have had a causal impact on a financial transactions anomaly within the transaction network at operation 620. Next, at operation 625, trending hashtag(s) or handles on a social media network may be identified for economic indicators which are new, or which have not previously otherwise been monitored and which are similar to one or more economic indicators of the set of economic indicators. For example, a semantic similarity process or machine-learning process such as Word2Vec may be utilized to identify similar economic indicators.

Word2vec comprises a group of related models which may be used to produce word embeddings. These models may comprise shallow, two-layer neural networks that may be trained to reconstruct linguistic contexts of words. Word2vec may take, as its input, a relatively large corpus of text and may produce a vector space, which may comprise several hundred dimensions, with each unique word in the corpus being assigned a corresponding vector in the space. Word vectors may be positioned in the vector space such that words that share common contexts in the corpus are located in close proximity to one another in the space. Such a word embedding approach may capture multiple different degrees of similarity between words, for example. A neural word embedding may represent a word with numbers.

Word2vec may encode each word in a vector, but rather than training against the input words through reconstruction, word2vec trains words against other words that neighbor them in the input corpus. It does so in one of two ways, either using context to predict a target word (a method known as continuous bag of words), or using a word to predict a target context, which is called skip-gram.

Global Vectors (GloVe) and fastText are additional word vector models which may be utilized to produce word embeddings. For example, GloVe and fastText comprise lookup table embeddings. GloVe, for example, comprises a count-based model which may treat each word in a corpus like an atomic entity and may generate a vector for each word.

fastText is a word embedding method which is an extension of the word2vec model. Instead of learning vectors for words directly, fastText represents each word as an n-gram of characters. For example, for word “artificial” with n=3, a fastText representation of this word is <ar, art, rti, tif, ifi, fic, ici, ial, al>, where the angular brackets indicate the beginning and end of the word.

fastText may help capture the meaning of shorter words and allow embeddings to understand suffixes and prefixes. Once a word has been represented using character n-grams, a skip-gram model may be trained to learn the embeddings. A skip-gram model is considered to be a bag of words model with a sliding window over a word because no internal structure of the word is taken into account. For example, as long as characters are within this window, the order of the n-grams does not matter. fastText may work well with rare words. Accordingly, even if a word was not seen during training, the word may be broken down into n-grams to determine its embeddings, for example.

Referring back to FIG. 6, at operation 630, a determination may be made as to whether there are any economic indicator anomalies within the new economic indicator(s) within the same time frame as monitored at operation 605. If “no,” processing may proceed to operation 605. If “yes,” on the other hand, processing may proceed to operation 635 where a determination may be made as to whether any of the economic indicator anomalies within the newly identified economic indicator(s) had a causal impact on a financial transactions anomaly detected within the transaction network. If “no” at operation 635, processing may advance to operation 605. If “yes,” on the other hand at operation 635, associated counters may be generated at operation 640 for the newly determined economic indicators which were determined to have a causal impact on a financial transactions anomaly on the transaction network. Next, at operation 645, the newly identified economic indicator(s) determined to have had a causal impact on the transaction network may be added to the set of economic indicators for further monitoring or consideration, for example.

Some portions of the detailed description are presented herein in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computing and/or device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as computing and/or communication protocols (e.g., network protocols), may interoperate within a larger network. In this context, the term sub-network and/or similar terms, if used, for example, with respect to a network, refers to the network and/or a part thereof. Sub-networks may also comprise links, such as physical links, connecting and/or coupling nodes, such as to be capable to transmit signal packets and/or frames between devices of particular nodes, including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting transmissions. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but devices outside the private network may not necessarily be able to direct inbound network communications to devices included in the private network.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof

What is claimed is:

1. A method, comprising:
processing a set of indicators from an indicator repository;
detecting an indicator anomaly within one of more of the individual indicators of the set of indicators based, at least in part, on a threshold increase in publication of the one or more of the individual indicators within a particular time period;
determining whether one or more particular indicators of the set of indicators had a causal impact on a transactions anomaly within the particular time period; and
generating a notification to identify the one or more particular indicators at least particularly in response to the determining that the one or more particular indicators of the set of indicators had a causal impact on a transactions anomaly.

2. The method of claim 1, wherein detection of the indicator anomaly is based on a time series of data points for the individual indicators.

3. The method of claim 2, wherein detection of the indicator anomaly is based on a moving average of the time series of data points for the individual indicators.

4. The method of claim 1, further comprising identifying additional indicators based on semantic similarity between the additional indicators and the set of indicators.

5. The method of claim 1, wherein the casual impact is based on a determination of a Granger causality.

6. The method of claim 1, wherein the particular time period comprises a moving time window.

7. The method of claim 1, further comprising incrementing a counter associated with a particular one of the determined one or more particular indicators determined to have had the causal impact within the particular time period.

8. A system, comprising:
an indicator repository to store a set of indicators;
an anomaly detection server to:
detecting an indicator anomaly within one of more of the individual indicators of the set of indicators based, at least in part, on a threshold increase in publication of the one or more of the individual indicators within a particular time period;
determine whether one or more particular indicators of the set of indicators had a causal impact on a transactions anomaly within the particular time period; and
a notification server to generate a notification to identify the one or more particular indicators at least particularly in response to the determination that the one or more particular indicators of the set of indicators had a causal impact on a transactions anomaly.

9. The system of claim 8, wherein the anomaly detection server is to detect the indicator anomaly is based on a time series of data points for the individual indicators.

10. The system of claim 8, wherein the anomaly detection server is to detect the indicator anomaly based on a moving average of the time series of data points for the individual indicators.

11. The system of claim 8, wherein the anomaly detection server is to identify additional indicators based on semantic similarity between the additional indicators and the set of indicators.

12. The system of claim 8, wherein the anomaly detection server is to identify the casual impact based on a determination of a Granger causality.

13. The system of claim 8, wherein the particular time period comprises a moving time window.

14. An article, comprising:
a non-transitory storage medium comprising machine-readable instructions executable by a special purpose apparatus to:
process a set of indicators from an indicator repository;
detect an indicator anomaly within one of more of the individual indicators of the set of indicators based, at least in part, on a threshold increase in publication of the one or more of the individual indicators within a particular time period;
determine whether one or more particular indicators of the set of indicators had a causal impact on a transactions anomaly within the particular time period; and
generate a notification to identify the one or more particular indicators at least particularly in response to the determining that the one or more particular indicators of the set of indicators had a causal impact on a transactions anomaly.

15. The article of claim 14, wherein the machine-readable instructions are further executable by the special purpose apparatus to detect the indicator anomaly based on a time series of data points for the individual indicators.

16. The article of claim 14, wherein the machine-readable instructions are further executable by the special purpose apparatus to detect the indicator anomaly based on a moving average of the time series of data points for the individual indicators.

17. The article of claim 14, wherein the machine-readable instructions are further executable by the special purpose apparatus to identify additional indicators based on semantic similarity between the additional indicators and the set of indicators.

18. The article of claim 14, wherein the machine-readable instructions are further executable by the special purpose apparatus to identify the casual impact based on a determination of a Granger causality.

19. The article of claim 14, wherein the particular time period comprises a moving time window.

20. The article of claim 14, wherein the machine-readable instructions are further executable by the special purpose apparatus to increment a counter associated with a particular one of the determined one or more particular indicators determined to have had the causal impact within the particular time period.
